(19) United States
(12) Patent Application Publication
(10) Pub. No.: US 2009/0288092 A1
(43) Pub. Date: Nov. 19, 2009

(54) Systems and Methods for Improving the Reliability of a Multi-Core Processor

(76) Inventor: Hiroaki Yamaoka, Austin, TX (US)

Correspondence Address: LAW OFFICES OF MARK L. BERRIER, 3811 BEE CAVES ROAD, SUITE 204, AUSTIN, TX, 78746, US

(21) Appl. No.: 12/120,788

(22) Filed: May 15, 2008

(51) Int. Cl. G06F 9/50

(52) U.S. Cl. 718/104

(57) ABSTRACT

Systems and methods for improving the reliability of multiprocessors by reducing the aging of processor cores that have lower performance. One embodiment comprises a method implemented in a multiprocessor system having a plurality of processor cores. The method includes determining performance levels for each of the processor cores and determining an allocation of the tasks to the processor cores that substantially minimizes aging of a lowest-performing one of the operating processor cores. The allocation may be based on task priority, task weight, heat generated, or combinations of these factors. The method may also include identifying processor cores whose performance levels are below a threshold level and shutting down these processor cores. If the number of processor cores that are still active is less than a threshold number, the multiprocessor system may be shut down, or a warning may be provided to a user.

### BACKGROUND

1. Field of the Invention

The invention relates generally to multiprocessors, and more particularly to systems and methods for improving the reliability of multiprocessors by reducing the aging of processor cores that have lower performance.

2. Related Art

The demand for improved electronic and computing devices continually drives the development of smaller, faster and more efficient devices. In order to build smaller, yet more computationally powerful devices, it is necessary to scale down the components of these devices. For instance, the dimensions of transistors have been driven downward to the limits of current technologies.

As the dimensions of components such as transistors have been scaled down, factors that were not as significant in designs using larger components have become more important. For instance, although power supply voltages have been reduced in some designs in order to conserve power, the reduction has not been as substantial as the reduction in the size of transistors. As a result, factors such as negative bias temperature instability (NBTI) and hot carrier injection (HCI) have a greater impact on the reliability of circuit designs. These factors can cause the performance of circuit components to degrade more quickly than in designs using larger components. As these individual components degrade, they can cause the systems in which they are used to experience reduced performance or even fail.

Referring to FIG. 1, a diagram showing the degradation of the performance of a transistor over time is illustrated. The graph in FIG. 1 shows frequency as a function of time. The performance of the transistor is indicated by curve 100, which plots the maximum operating frequency of the transistor over time. When a device is used, operating voltages are applied to the transistors in the device, and the transistors are switched on and off repeatedly. This is normal and necessary in the operation of the device, but it causes wear on the transistor which reduces the performance of the transistor. Other factors, such as heat can also cause the performance of the transistor to degrade. Thus, as shown in FIG. 1, the maximum operating frequency of the transistor is gradually reduced. This reduction in performance may be referred to as “aging.”

When a device is first constructed, the transistors in the device should all have a maximum operating frequency which is above the operating frequency of the device. This allows the transistors to switch quickly enough to generate, convey or otherwise act on signals within the device. If the maximum operating frequency of a transistor falls below the operating frequency of the device, the transistor may not be able to switch quickly enough in some instances, and may therefore cause errors in the device. The device may then be unreliable, or it may fail entirely.

Multiprocessor devices, like other devices, are subject to the aging of their components. The aging of these components causes the performance of processor cores within the multiprocessor device to degrade over time. As the performance of each processor core degrades, the cores may fall below a threshold level of performance, at which they fail or are no longer reliable. The performance of each processor core may differ from that of the other cores, so that the different processor cores fall below the threshold level of performance at different times. While the multiprocessor device may be able to continue to function with less than all of the processor cores operating, it typically requires some minimum number of processor cores to maintain adequate performance, so it will normally be considered to have reached the end of its useful life when a certain number of the processor cores have failed.

It would therefore be desirable to provide systems and methods which can extend the useful life of a multiprocessor by minimizing the effects of aging on the processor cores, and particularly on ones of the processor cores that have the lowest performance and are therefore most likely to fall below the threshold level of performance at which the processor cores are considered to be reliable and operational.

### SUMMARY OF THE INVENTION

One or more of the problems outlined above may be solved by the various embodiments of the invention. Broadly speaking, the invention includes systems and methods for improving the reliability of multiprocessors by reducing the aging of processor cores that have lower performance.

One embodiment comprises a method implemented in a multiprocessor system having a plurality of processor cores. The method includes determining performance levels for each of the processor cores and determining an allocation of the tasks to the processor cores that substantially minimizes aging of a lowest-performing one of the operating processor cores. The method may also include identifying processor cores whose performance levels are below a threshold level and shutting down these processor cores. If the number of processor cores that are still active is less than a threshold number, the multiprocessor system may be shut down, or a warning may be provided to a user.

The tasks may be allocated to the processor cores in various ways, including holding the lowest-performing processor core idle, prioritizing the tasks and assigning the lowest-priority tasks to the lowest-performing processor core, determining weights of the tasks and assigning the lightest task to the lowest-performing processor core, and assigning the tasks that generate the most heat to the processor core which is most distant from the lowest-performing processor core. The performance levels of the processor cores may be determined at intervals on the order of days, while the allocation of tasks to the processor cores may be performed continuously. The performance level of the processor cores may be determined by counting the oscillations of ring oscillators in the processor cores during a predetermined interval to identify maximum operating frequencies of the cores.

Another embodiment comprises a multiprocessor system having a multiple processor cores and a processor controller. The processor controller is configured to determine a performance level for each of the processor cores and to determine an allocation of tasks to the processor cores that substantially minimizes aging of the lowest-performing processor core. The system may include multiple aging monitors, each of which is implemented in a corresponding one of the processor cores. The aging monitors are controlled by the processor controller to determine each processor core's performance level. The aging monitors may determine the performance levels of the corresponding processor cores by determining the maximum operating frequency of the processor core. Each aging monitor may include a ring oscillator and a counter configured to count a number of oscillations of the ring oscillator in a predetermined amount of time.

The processor controller may be configured to identify processor cores having performance levels which are less than a threshold level and to shut down these processor cores. The processor controller may be configured to shut down the system or provide a warning a user if the number of processor cores that are still active is less than a threshold number. The processor controller may be configured to minimize aging of te lowest-performing core by holding the lowest-performing processor core idle, assigning the lowest-priority tasks to the lowest-performing processor core, assigning the lightest task to the lowest-performing processor core, and assigning the tasks that generate the most heat to the processor core which is most distant from the lowest-performing processor core. The processor controller may be configured to determine the performance levels of the processor cores at intervals on the order of days, and perform allocation of tasks to the processor cores continuously.

Numerous additional embodiments are also possible.

The various embodiments of the present invention may provide a number of advantages over the prior art. In particular, by reducing he aging of lower-performing processor cores, the useful life of the multiprocessor system that uses the cores may be extended in comparison to prior art systems allocate tasks to the processor cores without regard to the effects of aging.

### BRIEF DESCRIPTION OF THE DRAWINGS

Other objects and advantages of the invention may become apparent upon reading the following detailed description and upon reference to the accompanying drawings.

FIG. 1 is a diagram illustrating the degradation of the performance of a transistor over time.

FIG. 2 is a diagram illustrating an example of the effects of aging on multiple processor cores in a prior art multiprocessor.

FIG. 3 is a diagram illustrating an example of the effects of aging on multiple processor cores in accordance with one embodiment of the present invention.

FIG. 4 is a functional block diagram illustrating the structure of a multiprocessor system in accordance with one embodiment.

FIG. 5 is a functional block diagram illustrating the structure of the aging monitor and processor controller in accordance with one embodiment.

FIG. 6 is a flow diagram illustrating the detection and shutdown of unreliable processor cores based on aging monitoring in accordance with one embodiment.

FIG. 7 is a flow diagram illustrating the updating of processor core performance information based on aging monitoring in accordance with one embodiment.

FIG. 8 is a flow diagram illustrating the allocation of tasks to processor cores based on task priorities and processor core priorities in accordance with one embodiment.

FIG. 9 is a functional block diagram illustrating the allocation of tasks to the processor cores based upon task priorities and processor performance levels in accordance with one embodiment.

FIG. 10 is a functional block diagram illustrating the allocation of tasks to the processor cores based upon computational weights associated with the tasks, as well as processor core performance levels in accordance with one embodiment.

FIG. 11 is a functional block diagram illustrating the allocation of tasks to the processor cores based upon heat generated by execution of the tasks and the physical positions of the processor cores in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for improving the reliability and extending the life of a multiprocessor system by reducing the aging of the lowest performing processor cores in the system.

In one embodiment, a multiprocessor system includes a set of processor cores that are coupled to an arbiter and bus unit, as well as a processor controller. Data and tasks are communicated to and from the processor cores through the arbiter and bus unit. The processor controller determines which tasks are allocated to each of the processor cores.

In this embodiment, each of the processor cores includes an aging monitor. The aging monitor is configured to enable measurement of the corresponding processor core's maximum operating frequency, which can then be used as an indication of the performance level of the processor core. The processor controller periodically triggers the aging monitors in the processor cores and then records the maximum operating frequency of each of the processor cores. The maximum operating frequencies are then used by the processor controller to determine which of the cores have higher performance, and which have lower performance. Based upon the measured performance levels, the processor controller determines whether or not any of the processor cores have fallen below the threshold performance level and should be shut down. The processor controller also uses the performance levels as the basis for allocating tasks to the processor cores in a manner which causes less aging of the lower-performing cores. Ideally, the allocation of tasks to the processor cores substantially minimizes the aging of the lowest-performing core.

The processor controller in this embodiment takes into account a number of factors in determining the allocation of tasks to the processor cores. One factor is whether all of the processor cores are required for the performance of the tasks to be allocated. For instance, if there are eight processor cores and six tasks, the processor controller can allocate the tasks to the six highest-performing processor cores, while the two lowest-performing cores are left idle. Another factor is the weight of the tasks to be allocated. The processor controller can allocate heavier tasks (those which are more computationally intensive and therefore cause greater aging) to higher-performing processor cores, while lighter tasks are allocated to lower-performing cores. Yet another factor is the heat that is generated by the processor cores as they execute the allocated tasks. Because higher temperatures cause greater aging, tasks that are expected to cause more heat to be generated by the processor cores that execute these tasks are assigned to cores which are physically more distant from lower-performing cores. Various combinations of these and other factors can be taken into account by the processor controller in allocating tasks to the different processor cores.

As noted above, the present systems and methods are implemented in multiprocessor systems having a plurality of processor cores. In multiprocessor systems, the processor cores typically operate cooperatively, but independently. In other words, although each processor core may perform in operations that are part of a single, larger application, each core typically performs the tasks that are allocated to it independent of the other cores. Each processor core must therefore operate at or above a particular performance threshold. If a particular processor core falls below this threshold performance level, it is not considered to be reliable, and is shut down. The remaining processor cores, however, can continue to operate as long as they are performing at or above the threshold level. Many multiprocessor systems are designed to continue operating even though one or more of the processor cores are shut down as a result of being defective or underperforming.

In a system having a single processor, the system is typically either operative or inoperative, based upon the ability of the processor to perform at or above an acceptable level of performance. Consequently, as the processor ages, its performance gradually degrades and, at some point, fails (i.e., falls below the performance threshold.) Since there is only a single processor which performs all of the tasks of the system, the effects of aging are essentially unavoidable. In a multiprocessor system, on the other hand, some processor cores initially have better performance than others, and can therefore tolerate more aging than other processors before falling below the performance threshold. The present systems and methods take advantage of this by allocating tasks to the processor cores into a way that distributes more of the aging effects to the processor cores that are more capable of tolerating these effects.

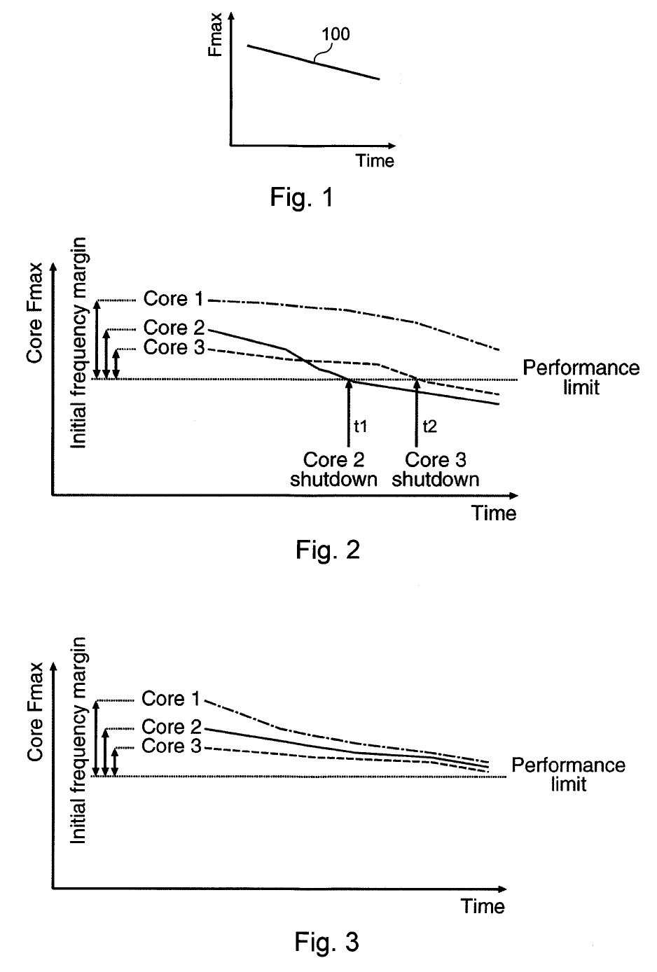

Referring to FIG. 2, a diagram illustrating an example of the effects of aging on multiple processor cores is shown. FIG. 2 is a graph of performance as a function of time for three exemplary processor cores (“core 1”, “core 2” and “core 3”.) As in FIG. 1, the performance level of each processor core is indicated by the corresponding maximum operating frequency (Fmax) of the core.

It can be seen in the figure that core 1 is initially the highest-performing core, followed by core 2 and then core 3. Over time, each of the processor cores ages and the corresponding performance degrades. The amount of aging and resulting degradation depends on various factors, as described above, and may be better tolerated by some processor cores than by others. It can be seen in FIG. 2 that core 1 experiences the least amount of aging and degradation. Core 3 experiences degradation which is similar to that of core 1. Core 2 experiences the greatest effects of aging and degrades more quickly than either core 1 or core 3. As a result, core 2 falls below the minimum performance limit at time t1, making it necessary to shut down this core. Similarly, at time t2, core 3 falls below the minimum performance threshold so that it must be shut down as well. Core 1, meanwhile, remains well above the performance threshold.

If in the multiprocessor system represented in FIG. 2, operation of the system could not continue without all three of the processor cores, the useful life of the system would end at time t1. If the system could tolerate a single processor core failure, but not the failure of two cores, the useful life of the system would end at time t2. The present systems and methods are designed to extend the useful lives of core 2 and core 3 by shifting tasks that cause greater aging away from these processor cores (e.g., executing them instead on core 1.) Even though this may shorten the useful life of core 1, the useful life of the overall system is extended. This is illustrated in FIG. 3.

Referring to FIG. 3, a diagram illustrating the effects of aging on processor cores 1, 2 and 3 using the present methodologies is shown. As in FIG. 2, core 1 is initially the highest-performing processor core, followed by core 2, and then core 3. Because core 1 has the highest performance level, tasks that cause the greatest amount of aging are allocated to core 1, while tasks that cause less aging are allocated to cores 2 and 3. More specifically, because core 3 has the lowest performance level, tasks that cause the least amount of aging are assigned to that processor core. As a result of this allocation of tasks, core 1 experiences more aging and its performance degrades more rapidly, but none of the three processor cores falls below the minimum performance threshold. Thus, the useful life of the system incorporating the three processor cores is extended in comparison to the example of FIG. 2.

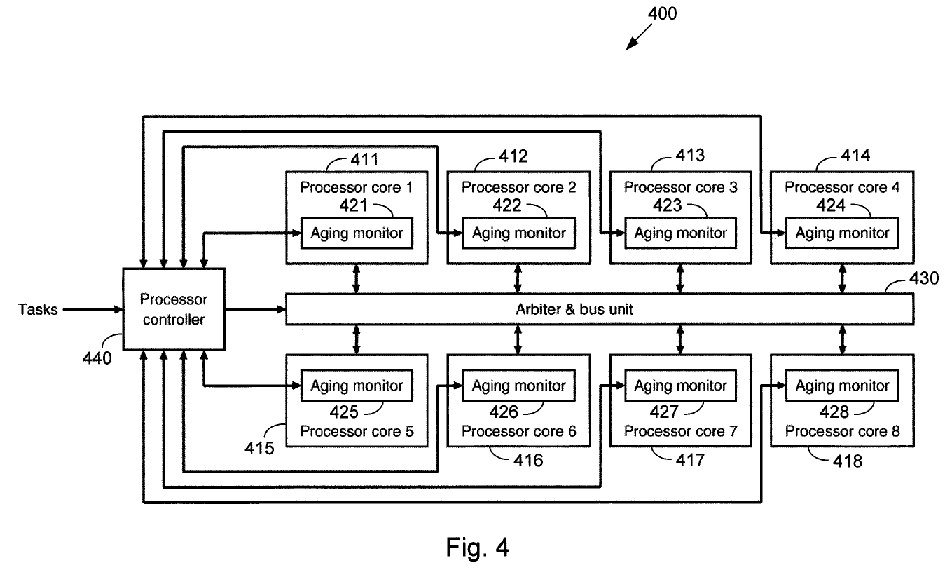

Referring to FIG. 4, a functional block diagram illustrating the structure of a multiprocessor system in accordance with one embodiment is shown. In this embodiment, multiprocessor system 400 includes eight processor cores 411-418. Each of the processor cores is coupled to an arbiter and bus unit 430, which is coupled to processor controller 440. The system also includes eight aging monitors 421-428, each of which is implemented in a corresponding one of processor cores 411-418. Each of aging monitors 421-428 is coupled to processor controller 440.

In this embodiment, tasks that are to be executed by the system are provided to processor controller 440. Processor controller 440 determines how the tasks will be allocated among processor cores 411-418 and also shuts down ones of the processor cores that fall below a performance threshold. Processor controller 440 with forwards the tasks to arbiter and bus unit 430, along with information regarding the allocation of the tasks. Arbiter and bus unit 430 forwards each task to the processor core to which the task was allocated by processor controller 440. Each of processor cores 411-418 executes the tasks that were assigned to that processor core and provides any resulting data to arbiter and bus unit 430 so that it can be routed to the appropriate destination (e.g., one of the other processor cores or peripheral component/device.)

As noted above, the performance level of each of processor cores 411-418 is periodically checked. Because the degradation of the processor cores' performance may be very gradual, it is contemplated that the cores' performance will be checked at intervals of 10-20 days, although longer or shorter intervals as short as one day could be appropriate for some devices. The checking of the processor cores' performance is done using aging monitors 421-428. Processor controller 440 is configured to periodically trigger the aging monitors to measure a performance metric such as the maximum operating frequency (Fmax) for corresponding ones of the processor cores. This performance information is provided by the aging monitors to the processor controller. The processor controller uses the performance information in determining how the tasks will be allocated to the different processor cores.

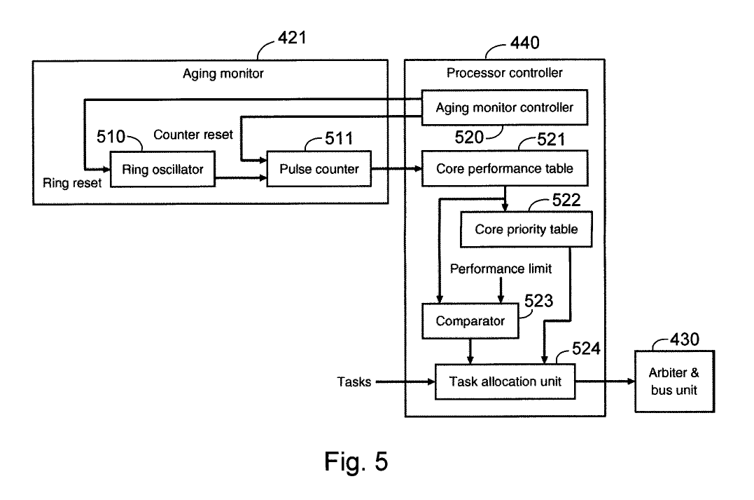

Referring to FIG. 5, a functional block diagram illustrating the structure of the aging monitor and processor controller is shown. It should be noted that, although a single aging monitor is depicted in the figure for purposes of clarity, separate aging monitors corresponding to each of the processor cores are connected to the processor controller in the same manner as the aging monitor depicted in the figure.

Each aging monitor (e.g., 421) in this embodiment includes a ring oscillator 510 and a pulse counter 511. Ring oscillator 510 may have any of a variety of structures designed to generate an oscillating signal. For example, ring oscillator 510 may comprise an odd-numbered series of inverters that are arranged end-to-end in a ring. Thus, a signal transition that is injected at one point in the ring propagates through each of the inverters and returns to the point at which it was injected. The signal does not stop at this point, but continues to propagate through the inverters. This produces a signal which alternately transitions from high to low and from low to high at regular intervals similar to a clock signal. The oscillator is free-running, so the frequency of the transitions is dependent upon the speed at which the signal propagates through the inverters.

The inverters and/or other components of the ring oscillator are constructed in the same manner as the critical path circuits and easily degraded circuits of the processor core, so the aging of the processor core components is mirrored by the components of the ring oscillator. Thus, as the performance of the processor core degrades, the performance of the ring oscillator's components also degrades. Consequently, the speed at which signals propagate through the ring oscillator degrades, and the frequency of oscillation is reduced. The frequency of oscillation of the ring oscillator is therefore an indicator of the speed and corresponding performance level of the processor core.

A pulse counter 511 is coupled to ring oscillator 510. Pulse counter 511 is configured to detect the signal transitions that occur in the ring oscillator as the signal transition propagates through the inverters around the ring. Pulse counter 511 is configured to count these signal transitions. By counting the number of signal transitions that occur in the ring oscillator during a predetermined interval, the frequency of the ring oscillator can be determined.

When it is desired to test the performance of the processor cores, the aging monitors (e.g., 421) are triggered by a signal (or signals) from the processor controller 440. This signal resets the ring oscillator (e.g., 510) and the pulse counter (e.g., 511.) When the ring oscillator is reset, a signal transition is injected into the oscillator to ensure that it oscillates during the test interval. At the same time, the pulse counter is reset to zero said that it can begin counting the number of oscillations in the ring oscillator during the test interval. At the end of the test interval, the processor controller stops the pulse counter, and the number of oscillations counted by the counter is output to the processor controller.

As noted above, the processor controller (440) periodically sends signals to the aging monitors to trigger tests of the corresponding processor cores' performance levels (maximum frequencies.) The processor controller therefore includes an aging monitor controller 520. The aging monitor controller generates the reset signals that initiate oscillation of the ring oscillator and reset the pulse counter to zero, waits for the predetermined test interval, and then generates a signal that stops the pulse counter and causes it to output the counted number of pulses.

The pulse count generated by the aging monitor is received by processor controller 440 and is stored in a core performance table 521. The core performance table stores the oscillation counts for each of the processor cores and uses the count corresponding to each processor core as an indication of the performance level of that core.

The processor core performance levels stored in the core performance table are used to rank the processor cores by their respective performance levels. In other words, based on the performance levels in the core performance table, the processor controller determines which processor core has the highest performance, which core has the next-highest performance, and so on. This ranked (prioritized) list is then stored in a core priority table 522. The core priority table can then be used to facilitate allocation of tasks based on the performance levels of the respective processor cores. The performance levels stored in the core performance table are also compared (via comparator 523) to a value that represents a minimum performance threshold. If the performance level (maximum frequency) of a particular processor core is less than this threshold value, the processor core is considered unreliable and is shut down.

Processor controller 440 includes a task allocation unit 524 that receives information from core priority table 522 and comparator 523, and uses this information in order to determine whether to shut down any of the processor cores and how tasks should be allocated to the different processor cores. The task allocation unit then forwards received tasks to the appropriate processor cores via the arbiter and bus unit 430.

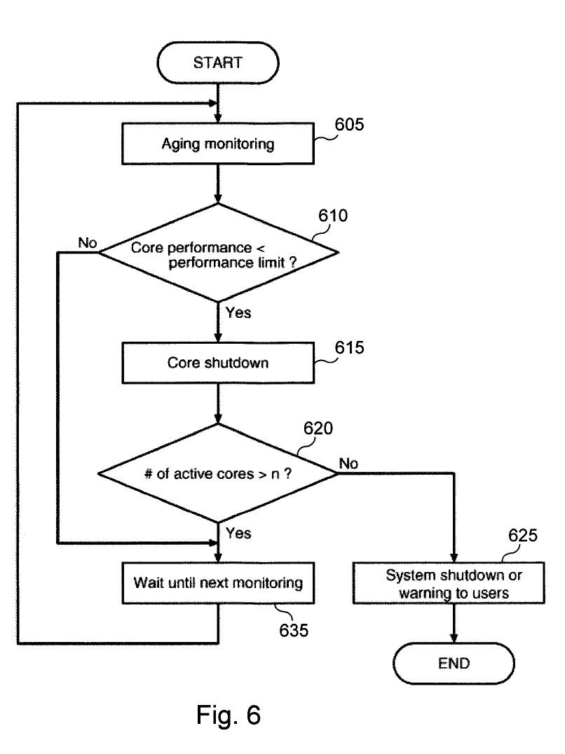

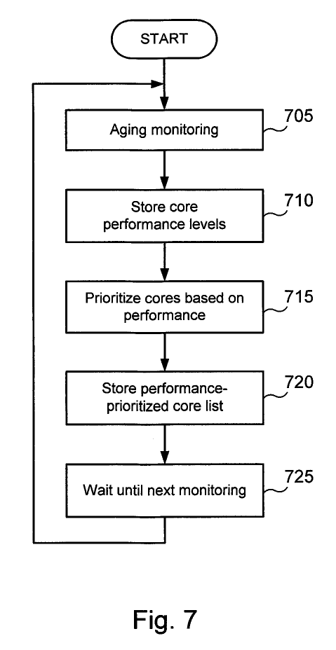

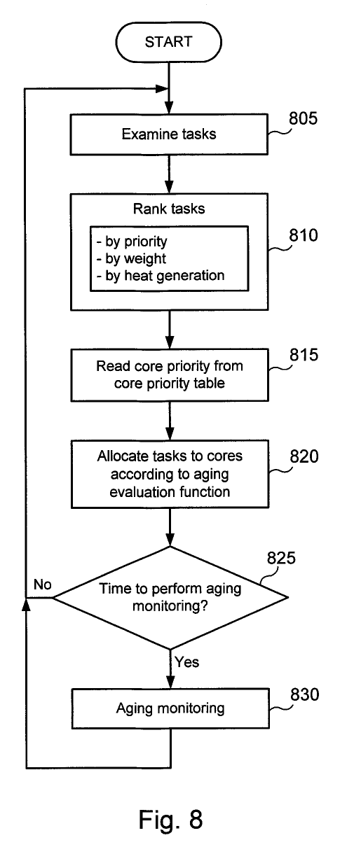

Referring to FIGS. 6-8, a pair of flow diagrams illustrating the operation of the system with respect to aging of the processor cores are shown. FIG. 6 illustrates the detection and shutdown of unreliable processor cores based on aging monitoring. FIG. 7 illustrates the updating of processor core performance information based on aging monitoring. FIG. 8 illustrates the allocation of tasks to processor cores based on task priorities and processor core priorities (which are based on aging monitoring.)

Referring to FIG. 6, the detection of unreliable processor cores begins with aging monitoring (605.) Aging monitoring consists, in this embodiment, of determining the oscillation frequencies of each processor core as described above and storing this information in the processor controller. Then, the oscillation frequency of each processor core (the core performance) is compared to a threshold frequency (the performance limit) (610.) If the oscillation frequency of a particular processor core is less than the threshold frequency, that processor core is shut down (615.) If a processor core has to be shut down, the system determines whether the number of active processor cores (the cores that have not been shut down) is greater than or equal to a minimum number (n) of cores that are required for acceptable performance (620.) If the number of active processor cores is below this minimum number, the system may be shut down, or a warning may be provided to the users of the system (625.) Returning to 610, if none of the processor cores' oscillation frequencies are less than the threshold, no action is required, so the process waits until the next time monitoring is triggered by the aging monitor controller (635.)

Referring to FIG. 7, the updating of core performance information is illustrated. This process begins with monitoring (testing) the aging of the processor cores (705.) This is the same testing that is performed in step 605 of FIG. 6. The oscillation frequencies (performance levels) that are generated by the aging monitors are output to the processor controller and are stored in the core performance table (710.) In this embodiment, the core performance table simply comprises a list of the processor cores (e.g., ordered by a core identifier) and the corresponding oscillation frequencies. The performance data from the core performance table is then prioritized (ordered) according to the respective oscillation frequencies (performance levels) of the processor cores (715.) A list of the processor cores, ordered according to their respective performance levels, is then stored in the core priority table (720) so that it can be used to facilitate the allocation of tasks. After this performance-prioritized information is stored, the process remains idle until the next time aging monitoring is triggered (725.)

Referring to FIG. 8, the allocation of tasks based on the aging information is illustrated. This process begins with the examination of the tasks that are received by the processor controller (805.) The received tasks are ranked, for example, according to their priority (810.) The tasks may alternatively be ranked according to their respective weights or other characteristics, as will be explained in more detail below. The processor controller then reads the processor core priorities that were previously stored in the core priority table (815.) The tasks will then be allocated in a manner that substantially minimizes the aging of the lowest-performing core. (“Substantially minimizes,” as used here, means that the allocation is intended to minimize the aging of the lowest-performing core, but the aging reduction may not be the absolute minimum that could be achieved.) The tasks will then be allocated based upon the priorities of the tasks and the processor cores and forwarded to the cores via the arbiter and bus unit (820.) After the tasks are forwarded, the processor controller determines whether it is time for a periodic check of the processor cores' aging (825.) If not, the processor controller will examine the next set of tasks and allocate them as described above (see 805-820.) If it is time for a performance test, the aging monitor controller will trigger a test of the processor cores' performance (830.) Then, the processor controller will examine and allocate the next set of tasks as in steps 805-820.

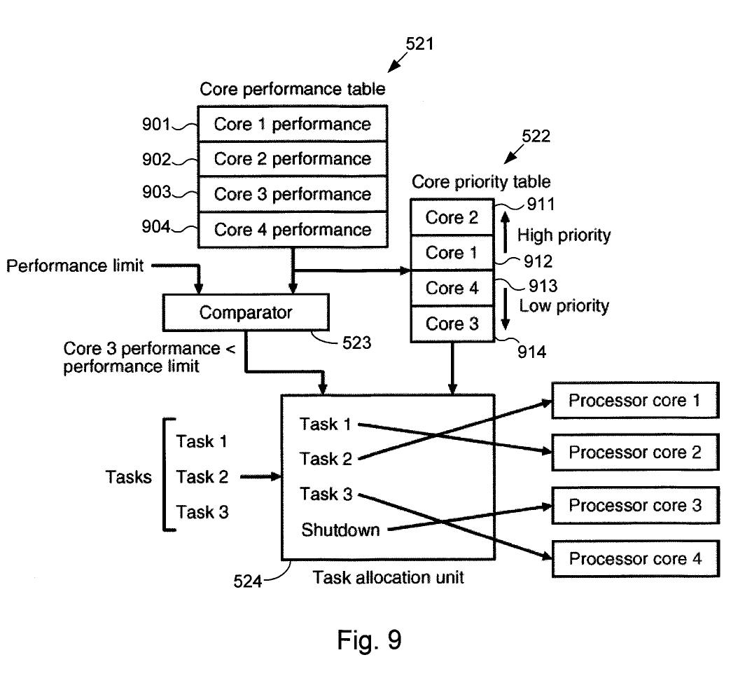

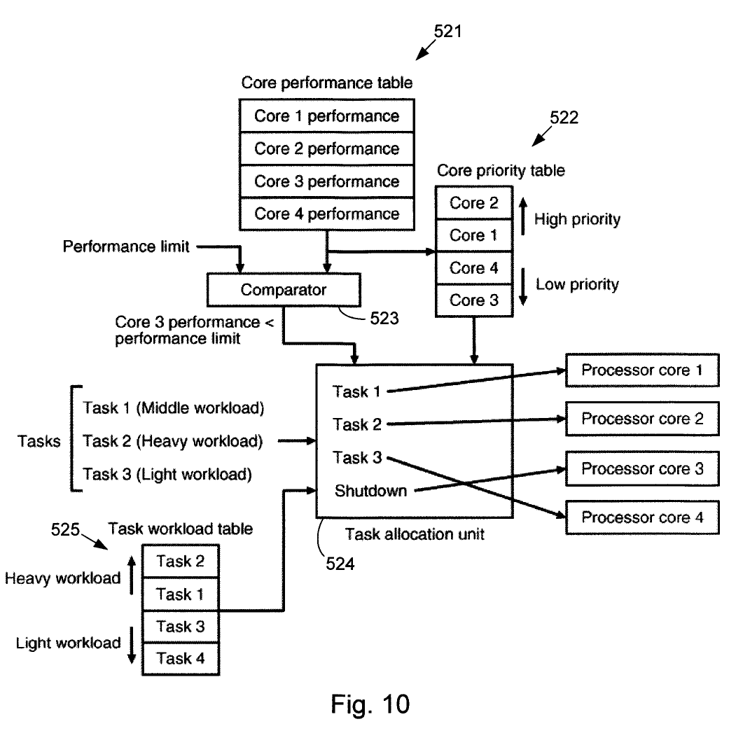

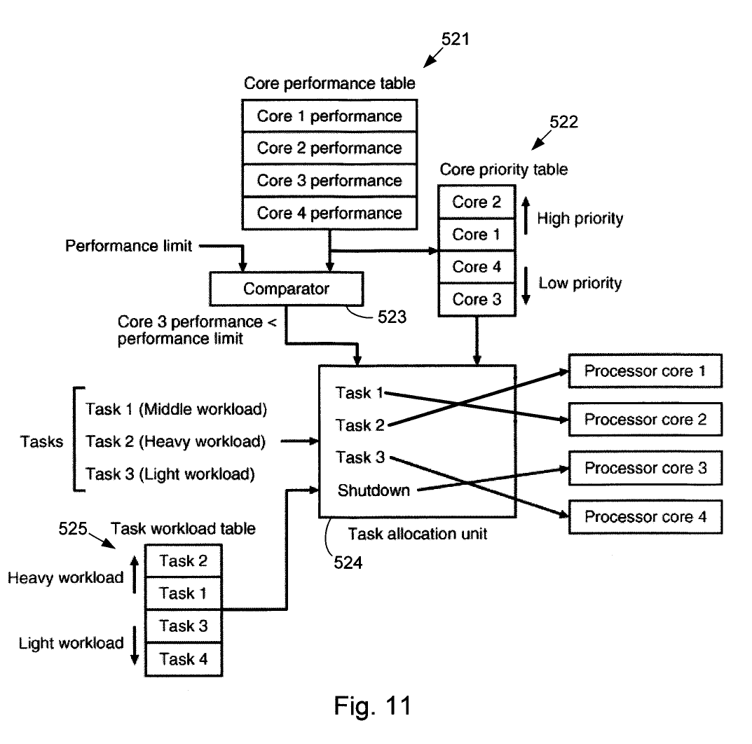

The allocation of tasks to the different processor cores is described below in connection with FIGS. 9-11. FIG. 9 is a functional block diagram illustrating the allocation of tasks to the processor cores based upon task priorities and processor performance levels. FIG. 10 is a functional block diagram illustrating the allocation of tasks to the processor cores based upon computational weights associated with the tasks, as well as processor core performance levels. FIG. 11 is a functional block diagram illustrating the allocation of tasks to the processor cores based upon heat generated by execution of the tasks and the physical positions of the processor cores. In FIGS. 9-11, it is assumed that there are four processor cores (core 1, core 2, core 3 and core 4.)

As noted above, negative bias temperature instability (NBTI) and hot carrier injection (HCI) cause the components of the processor cores to degrade. NBTI occurs under high voltage and high temperature conditions. HCI occurs under high voltage and during transistor switching activity. The task allocation unit of the processor controller therefore implements algorithms that allocate tasks in a manner that reduces high voltage conditions, high temperature conditions and transistor switching activity in low-performing processor cores.

Referring to FIG. 9, a portion of the processor controller is shown. Included in the figure are core performance table 521, core priority table 522, comparator 523 and task allocation unit 524. After the processor controller triggers performance tests in the aging monitors of the processor cores, the performance levels output by the aging monitors are stored in core performance table 521. In this embodiment, there is an entry for the performance of processor core 1 (901,) an entry for the performance of core 2 (902,) an entry for the performance of core 3 (903) and an entry for the performance of core 4 (904.) Because each entry is associated with a corresponding one of the processor cores, there is no need to store a processor core identifier along with the performance level.

As described above, the different processor cores are ranked according to performance level and stored in core priority table 522. That is, the highest-performing processor core is identified in the first entry (911,) the next-highest-performing processor core is identified in the next entry (912,) the third-highest performing processor core is identified in the third entry (913) and the lowest-performing processor core is identified in the last entry (914.) In this example, it is assumed that core 2 has the highest performance level, core 1 has the 2nd-highest performance level, core 4 has the third-highest performance and core 3 has the lowest performance level.

In the example of FIG. 9, it is assumed that the performance levels of processor cores 1, 2 and 4 are above a minimum performance limit, while the performance level of processor core 3 is below this limit. Consequently, when comparator 523 compares the performance of each processor core to the performance limit, it is determined by the processor controller that core 3 is unreliable. The processor controller therefore shuts down processor core 3. This information may be provided directly to task allocation unit 524 as shown in the figure, or it may be stored in the core priority table.

Based upon the processor core priority information and the information identifying cores that have been shut down, task allocation unit 524 determines how to allocate received tasks to the processor cores. The FIG. 9 shows three tasks (task 1, task 2 and task 3) that are received by the task allocation unit. In this example, task allocation unit 524 examines the tasks and ranks them according to their respective priorities. For the purposes of this example, task 1 has the highest priority, task 2 has the second-highest priority, and task 3 has the lowest priority. Because the task allocation unit is configured in this example to allocate the task space-time priority, the highest-priority task (task 1) is assigned to the highest-performance processor core (core 2.) Task 2 is the second-highest-priority task, so it is assigned to the second-highest-performance processor core (core 1.) The task 3 is the third-highest-priority task, so it is assigned to the third-highest-performance processor core (core 4.)

In the example of FIG. 9, processor core 3 has been shut down, so no tasks will be allocated to it by the task allocation unit. If the performance level of processor core 3 had been above the performance limit, it would have been available for allocation of a task. If there were three tasks to be allocated among four active processor cores, the tasks would still have been allocated to the three highest-performing processor cores, with the fourth processor core remaining idle.

FIG. 10 provides another example of the allocation of tasks to the processor cores. In this instance, the performance levels of processor cores 1-4 are assumed to be the same as in FIG. 9. Thus, the information stored in core performance table 521 and core priority table 522 is the same. Also, the performance of processor core 3 is assumed to be below the threshold performance limit (as determined by comparator 523,) so this core is shut down by the processor controller. In the example of FIG. 10, a task workload table 525 is coupled to task allocation unit 524. The task workload table contains information that defines the respective weights of the different tasks that may be allocated to the processor cores.

In the example of FIG. 10, task allocation unit 524 is configured to allocate tasks to the processor cores based on the weight of the tasks. “Weight” is used here to refer to the level of computational intensity of the tasks. “Heavy” tasks are computationally intensive and consequently place a greater workload on the processor cores as they execute these tasks. Execution of heavy tasks results in relatively high levels of transistor switching, power usage, and the like, which ages the processor core to a relatively high degree. “Light” tasks, on the other hand, are less computationally intensive, require less processing of the associated data, and produce less wear on the processor core. Heavy tasks therefore cause greater aging of the processor cores than light tasks, and are consequently assigned to higher-performance processor cores that are better able to tolerate aging.

As shown in FIG. 10, the tasks received by task allocation unit 524 in this example include a light task (task 3,) a medium-weight task (task 1) and a heavy task (task 2.) Task allocation unit 524 allocates heavier-weight tasks to higher-performance processor cores, and lighter-weight tasks to lower-performance cores. Thus, task 2, which is a heavy task, is allocated to core 2, which has the highest level of performance. Task 1, which is a medium-weight task, is allocated to core 1, which has the second-highest level of performance. Task 3, which is a light task, is allocated to core 4, which has the third-highest level of performance. Since core 3 has been shut down, no tasks are assigned to this core. If core 3 were active, it could be allocated a light task, or it could be held idle.

FIG. 11 illustrates another example of the allocation of tasks to the processor cores. In this example, the allocation of the tasks is not based on the performance levels of the processor cores, but is instead based on the physical positions of the cores. As in the examples of FIGS. 9 and 10, the performance of processor core 3 is below the threshold performance limit, so it is shut down by the processor controller.

In this example, task allocation unit 524 is configured to allocate tasks to the processor cores based on the heat generated by the tasks. Task workload table 525 is again used by task allocation unit 524, but it is assumed in this case that the workload of each task is representative of the heat that will be generated by the processor core that performs the task. The tasks that generate the most heat are allocated to the processor cores that are most distant from the lowest-performing cores. Thus, since core 4 has the lowest performance of the active cores (cores 1, 2 and 4,) the tasks that generate the most heat will be allocated to the processor cores most distant from core 4.

Task 3, which has the lightest workload and generates the least amount of heat, is allocated to core 4, which has the lowest performance. Assuming that the four processor cores are aligned and ordered by their respective numbers (1, 2, 3, 4,) core 1 is the most distant from core 4, so it is allocated task 2 (which has the heaviest workload and the highest heat generation.) Task 1 is allocated to core 2. When the tasks are performed, most of the heat generated in connection with the tasks will be near processor core 1, while processor core 4 is subjected to the least amount of heat.

It should also be noted that, in the examples of FIGS. 9-11, no tasks were allocated to processor core 3 because the performance level of this processor core was below the threshold performance limit. In alternative embodiments, even if processor core 3 were active, the task allocation unit still might not allocate tasks to this processor core. For instance, if one or two of the tasks had a high priority, but the rest of the tasks had a low priority, the task allocation unit might be configured to delay allocation of the low-priority tasks in order to keep the lowest-performance processor core idle 50% of the time. If all of the tasks had high priority, the goal of keeping the lowest-performance processor core idle could be disregarded.

It should also be noted that the examples of FIGS. 9-11 address the concerns of priority, task weight and heat generation separately. Because the aging of the processor cores is a result of all three of these factors, the task allocation unit may be configured to take all three into account when allocating the tasks to the processor cores. Various algorithms and various functions of the different factors may be implemented to evaluate the aging effects of these factors and to generate appropriate task allocations.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

Those of skill will further appreciate that the various illustrative logical blocks, modules, circuits, and algorithm steps described in connection with the embodiments disclosed herein may be implemented as electronic hardware, computer software (including firmware,) or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

Those of skill in the art will understand that information and signals may be represented using any of a variety of different technologies and techniques. For example, data, commands, information, signals, bits, symbols, and the like that may be referenced throughout the above description may be represented by voltages, currents, electromagnetic waves, magnetic fields or particles, optical fields or particles, or any combination thereof.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A method implemented in a multiprocessor system having a plurality of processor cores, the method comprising:
determining, for each of a plurality of operating processor cores, a corresponding performance level
determining, for a plurality of tasks, an allocation of the tasks to the operating processor cores that substantially minimizes aging of a lowest-performing one of the operating processor cores

2. The method of claim 1, further comprising identifying one or more processor cores having performance levels which are less than a threshold level and shutting down the identified processor cores.

3. The method of claim 2, further comprising determining whether the number of operating processor cores is less than a threshold number and, when the number of operating processor cores is less than the threshold number, taking an action selected from the group consisting of: shutting down the multiprocessor system; and providing a warning to a user.

4. The method of claim 1, wherein determining the allocation of the tasks to the operating processor cores comprises determining that the tasks are fewer than the operating processor cores and assigning the tasks to ones of the operating processor cores other than the lowest-performing one of the operating processor cores.

5. The method of claim 1, wherein determining the allocation of the tasks to the operating processor cores comprises prioritizing the tasks and assigning the lowest-priority tasks to the lowest-performing one of the operating processor cores.

6. The method of claim 1, wherein determining the allocation of the tasks to the operating processor cores comprises determining weights of the tasks and assigning the lightest task to the lowest-performing one of the operating processor cores.

7. The method of claim 1, wherein determining the performance level corresponding to each of the operating processor cores is repeated at intervals of no less than 1 day.

8. The method of claim 7, wherein determining the allocation of the tasks to the operating processor cores is repeated substantially continuously.

9. The method of claim 1, wherein determining the performance level corresponding to each of the operating processor cores comprises determining a maximum operating frequency corresponding to each of the operating processor cores, wherein the lowest-performing one of the operating processor cores comprises the one of the operating processor cores having the lowest maximum operating frequency.

10. The method of claim 9, wherein determining the maximum operating frequency corresponding to each of the operating processor cores comprises implementing an identical ring oscillator in each of the processor cores and, for each of the processor cores counting a corresponding number of oscillations of the ring oscillator in a predetermined amount of time.

11. A multiprocessor system comprising:
a plurality of processor cores; and
a processor controller coupled to the processor cores,
wherein the processor controller is configured to
determine, for each of the processor cores, a corresponding performance level, and
determine, for a plurality of tasks, an allocation of the tasks to the processor cores that substantially minimizes aging of a lowest-performing one of the operating processor cores.

12. The multiprocessor system of claim 11, further comprising a plurality of aging monitors, wherein each of the aging monitors is implemented in a corresponding one of the processor cores, wherein the aging monitors are controlled by the processor controller to determine each processor core's corresponding performance level.

13. The multiprocessor system of claim 11, wherein each aging monitor is configured to determine the performance level of the corresponding processor core by determining a maximum operating frequency of the processor core, and wherein the processor controller is configured to identify the lowest-performing one of the processor cores as the one of the processor cores having the lowest maximum operating frequency.

14. The multiprocessor system of claim 13, wherein each aging monitor comprises a ring oscillator and a counter configured to count a number of oscillations of the ring oscillator in a predetermined amount of time.

15. The multiprocessor system of claim 11, wherein the processor controller is configured to identify one or more processor cores having performance levels which are less than a threshold level and to shut down the identified processor cores.

16. The multiprocessor system of claim 15, wherein the processor controller is configured to determine whether an operating number of processor cores that have not been shut down is less than a threshold number and when the operating number is less than the threshold number taking an action selected from the group consisting of: shutting down the multiprocessor system; and providing a warning to a user.

17. The multiprocessor system of claim 11, wherein the processor controller is configured to determine the allocation of the tasks to the processor cores by determining that the tasks are fewer than the processor cores and assigning the tasks to ones of the processor cores other than the lowest-performing one of the processor cores.

18. The multiprocessor system of claim 11, wherein the processor controller is configured to determine the allocation of the tasks to the processor cores by prioritizing the tasks and assigning the lowest-priority tasks to the lowest-performing one of the processor cores.

19. The multiprocessor system of claim 11, wherein the processor controller is configured to determine the allocation of the tasks to the processor cores by determining weights of the tasks and assigning the lightest task to the lowest-performing one of the processor cores.

20. The multiprocessor system of claim 11, wherein the processor controller is configured to determine the performance level corresponding to each of the processor cores periodically at intervals of no less than 1 day and wherein the processor controller is configured to determine the allocation of the tasks to the processor cores substantially continuously.
